(19) United States
(12) Patent Application Publication
(10) Pub. No.: US 2024/0286384 A1
(43) Pub. Date: Aug. 29, 2024

(54) COMPOSITION

(71) Applicant: SOCIETE DES PRODUITS NESTLE S.A., Vevey (CH)

(72) Inventor: CHENG MENG LAU, Johor Bahru (MY)

(21) Appl. No.: 18/571,335

(22) PCT Filed: Jun. 16, 2022
(86) PCT No.: PCT/IB2022/055557

§ 371 Date: Dec. 18, 2023

(30) Foreign Application Priority Data
Jun. 18, 2021 (EP) 21180188.1

(51) Int. Cl. B32B 17/08; B32B 27/32; B32B 33/00

(52) U.S. Cl. CPC B32B 17/08; B32B 27/325; B32B 33/00; B32B 2250/242; B32B 2255/10; B32B 2255/205; B32B 2307/514; B32B 2307/7244; B32B 2307/7246; B32B 2307/75; B32B 2323/04; B32B 2323/10

(57) ABSTRACT

The present invention provides a multi-layer film composition comprising: (i) a first layer comprising a cyclic olefin copolymer: (ii) a second layer comprising polyethylene; and (iii) a third layer comprising a polymer having a heat seal initiation temperature of no greater than about 170° C.: wherein the second layer is positioned between the first and third layers.

### FIELD OF THE INVENTION

The present invention relates to a multi-layer film composition, to methods of preparing the multi-layer film composition, to laminates containing the multi-layer film composition and to uses of the same.

### BACKGROUND TO THE INVENTION

Food and beverage products are often packaged using laminate film compositions, and may be packaged as ‘single-serve’ or ‘multi-serve’ products. A single-serve product contains a single portion or serving size of the food or beverage product contained within packaging, while a multi-serve product contains multiple portions or servings of the product within the packaging. The packaging in the multi-serve product may be resealable.

Packaging laminates may often include plastic polymers, such as polypropylene and polyethylene. These materials have been the subject of recent focus due to their recyclability. However, previously known packaging materials containing polypropylene and/or polyethylene have been found to encounter problems with delamination due to inconsistent bonds formed after sealing, inconsistent machinability flow, and relatively poor barrier properties. Such packaging materials may also have a relatively high tearing strength, which can result in it being more difficult for a user to manually tear the packaging in a straight line in order to open the packaging.

More recently, polyethylene has become of particular interest as it is considered to be more widely recyclable than polypropylene or polyolefin. However, in the history of barrier development, polyethylene films have been found to be challenging and such films may have relatively high permeability to moisture and gases.

It is generally desirable for such packaging materials to limit the amount of oxygen, water vapour and other gases or fluids that is able to permeate through to the products contained within the packaging as these gases can lead to undesirable reactions with the packaged products that lead to spoilage. For example, oxidative degradation can affect the flavour, colour of food and beverage products, such as coffee, tea, chocolate, meats, cheeses, and the like. Oxidative degradation may also lead to enhanced microbiological growth within a short period of time.

As such it would be desirable to reduce the permeability of the packaging film to these gases in order to enhance the shelf-life of food or drink products contained therein.

### SUMMARY OF THE INVENTION

In a one aspect there is provided a multi-layer film composition comprising:
(i) a first layer comprising a cyclic olefin copolymer;
(ii) a second layer comprising polyethylene; and
(iii) a third layer comprising a polymer having a heat seal initiation temperature of no greater than about 170° ° C.;
   wherein the second layer is positioned between the first and third layers.

In one aspect there is provided a multi-layer film composition comprising:
(i) a first layer comprising a cyclic olefin copolymer;
(ii) a second layer comprising polyethylene; and
(iii) a third layer comprising a polymer having a heat seal initiation temperature of no greater than about 170° C.;
   wherein the second layer is positioned between the first and third layers, and
   wherein the multi-layer film composition has a water vapour transmission rate of no greater than about 0.5 g/m² per day.

In one aspect there is provided a method of preparing a multi-layer film composition as described hereinabove, the method comprising:
(a) providing the first, second and third layers in separate containers;
(b) melting the polymers in the first, second and third layers in the separate containers; and
(c) combining the first, second and third layers to form a multi-layer film composition.

In one aspect there is provided a laminate comprising:
(a) a first barrier layer comprising a metallised multi-layer film composition as described herein;
(b) a second barrier layer comprising metallised oriented polypropylene; and
(c) an external printable layer comprising a polymer selected from oriented polypropylene, oriented polyethylene and combinations thereof.

In one aspect there is provided a use of a cyclic olefin copolymer in a multi-layer film composition comprising polyethylene for improving adhesion of the film composition to a metal layer.

In one aspect there is provided a use of a cyclic olefin copolymer for providing a metallised film composition having a water vapour transmission rate of no greater than 0.1 g/m² per day, the metallised film composition comprising the cyclic olefin copolymer.

As described herein, the present invention provides a multi-layer film composition which has excellent barrier properties, whilst also having high bonding strengths and relatively low tear strengths allowing for packaging made from said film composition being relatively easy to manually tear open in a straight line.

For ease of reference, these and further aspects of the present invention are now discussed under appropriate section headings. However, the teachings under each section are not necessarily limited to each particular section.

### BRIEF DESCRIPTION OF DRAWINGS

Embodiments of the present invention are described, by way of example only, with reference to the accompanying drawings in which:

FIG. 1 shows an embodiment of a multi-layer film composition comprising first, second and third layers.

FIG. 2 shows an embodiment of a multi-layer film composition comprising an external printable layer and a metal layer in addition to first, second and third layers.

FIG. 3 shows an embodiment of a laminate comprising a first barrier layer, a second barrier layer and an external printable layer.

FIG. 4 shows another embodiment of a laminate that further comprises an additional layer comprising polyethylene.

While the invention is susceptible to various modifications and alternative forms, specific embodiments are shown by way of example in the drawings and are herein described in detail. It should be understood, however, that the drawings and detailed description of the specific embodiments are not intended to limit the invention to the particular forms disclosed. On the contrary, the invention covers all modifications, equivalents and alternatives falling within the scope of the present invention as defined by the appended claims.

### DETAILED DESCRIPTION

### Composition

As discussed herein, in one aspect of the present invention, there is provided a multi-layer film composition comprising:
(i) a first layer comprising a cyclic olefin copolymer;
(ii) a second layer comprising polyethylene; and
(iii) a third layer comprising a polymer having a heat seal initiation temperature of no greater than about 170° C.;
   wherein the second layer is positioned between the first and third layers.

### First Layer

As described herein, the first layer in the multi-layer film composition comprises a cyclic olefin copolymer (COC). COC is an amorphous polymer that is typically produced by chain copolymerisation of cyclic monomers with a linear chain monomer (e.g. ethylene) using conventional initiators and/or metallocene initiators. The cyclic monomers may be selected from any suitable cyclic monomers, such as norbornene, tetracyclododecene (e.g. 1,2,3,4,4a,5,8,8a-octahydro-1,4:5,8-dimethanonaphthalene), or other derivatives of norbornene.

Where ethylene is used as the linear monomer, and norbornene as the cyclic monomer, the COC may have the following chemical structure, where the ethylene structure is designated “x” and the norbornene structure is designated “y”:

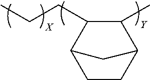

Methods of manufacturing COC resins are known to a person skilled in the art. Typically, COC may be produced by copolymerising ethylene with norbornene (or a derivative thereof) in the presence of a metallocene catalyst.

In some embodiments, the COC has a volume flow index (melt volume-flow rate, MVR) of from about 1 to about 200 cm³/10 min when measured at 260° C., 2.16 kg. In some embodiments, the COC has a volume flow index (melt volume-flow rate, MVR) of from about 1 to about 50 cm³/10 min when measured at 260° C., 2.16 kg. In some embodiments, the COC has an MVR of from about 2 to about 40 cm³/10 min, such as from about 5 to about 35 cm³/10 min when measured at 260° C., 2.16 kg. In some embodiments, the COC has an MVR of from about 0.5 to about 30 cm³/10 min when measured at 230° C., 2.16 kg, such as from about 2 to about 20 cm³/10 min, such as from about 5 to about 15 cm³/10 min, such as from about 10 to about 15 cm³/10 min when measured at 230° C., 2.16 kg. In some preferred embodiments, the COC has an MVR of about 12 cm³/10 min when measured at 230° C., 2.16 kg. In some embodiments, the COC has an MVR of from about 0.1 to about 20 cm³/10 min when measured at 190° C., 2.16 kg, such as from about 0.5 to about 15 cm³/10 min, such as from about 1 to about 10 cm³/10 min, such as from about 1.5 to about 5 cm³/10 min when measured at 190° C., 2.16 kg. In some preferred embodiments, the COC has an MVR of about 2 cm³/10 min when measured at 190° C., 2.16 kg The MVR may be measured using test method ISO 1133.

In some embodiments, the COC has a melt flow index (or melt flow rate) of from about 1 g/10 min to about 50 g/10 min when measured at 260° C., 2.16 kg, such as from about 10 to about 30 g/10 min when measured at 230° C., 2.16 kg. In some embodiments, the COC has a melt flow index (or melt flow rate) of from about 10 g/10 min to about 15 g/10 min when measured at 230° C., 2.16 kg. Preferably, the COC has a melt flow index of from about 10 g/10 min to about 12 g/10 min when measured at 230° C., 2.16 kg. In some embodiments, the COC has a melt flow index (or melt flow rate) of from about 0.1 g/10 min to about 5 g/10 min when measured at 190° C., 2.16 kg. Preferably, the COC has a melt flow index of from about 0.5 g/10 min to about 2.5 g/10 min when measured at 190° C., 2.16 kg. Preferably, the COC has a melt flow index of from about 1 g/10 min to about 2 g/10 min when measured at 190° C., 2.16 kg, and more preferably from about 1.5 to about 2 g/10 min when measured at 190° C., 2.16 kg. In some preferred embodiments, the COC has a melt flow index of about 1.9 g/10 min when measured at 190° C., 2.16 kg. The melt flow index may be calculated from ISO 1133 MVR using a melt density of 0.92.

In some embodiments, the COC has a heat deflection temperature under load (HDT/B (0.45 MPa)) of from about 50 to about 200° C., such as from about 75 to about 175° C. HDT/B may be measured using ISO 75, parts 1 and 2. In some embodiments, the COC has a heat deflection temperature under load (HDT/B (0.45 MPa)) of from about 50 to about 100° C.

In some embodiments, the COC has a glass transition temperature of up to about 180° C. In some embodiments, the COC has a glass transition temperature of from about 50 to about 180° C., such as from about 60 to about 150° C., such as from about 70 to about 125° C., such as from about 75 to about 100° C. In some preferred embodiments, the COC has a glass transition temperature of from about 50 to about 100° C. In some preferred embodiments, the COC has a glass transition temperature of from about 60 to about 80° C. The glass transition temperature may be measured using ISO 11357-1, -2, -3. In some preferred embodiments, the COC may have a glass transition temperature of about 78° C.

In some embodiments, the COC included in the first layer may be selected from a COC produced by TOPAS Advanced Polymers (e.g. TOPAS®), a COC produced by Mitsui Chemical (e.g. Apel®), or mixtures thereof. In some embodiments, the COC may be selected from TOPAS grades 8007, 5013, 6013, 6015, 6017, or mixtures thereof. In some embodiments, the COC may be selected from TOPAS® 8007F-600, TOPAS® 9506F-500, TOPAS® 7010F-600, TOPAS® 6013F-04, or mixtures thereof. In some embodiments, the COC may be TOPAS® 8007F-600.

In some embodiments, the first layer comprises COC in an amount of at least about 50% by weight of the first layer, such as at least about 60% by weight of the first layer, such as at least about 70% by weight of the first layer, such as at least about 80% by weight of the first layer, such as at least about 90% by weight of the first layer, such as at least about 95% by weight of the first layer, such as at least about 98% by weight of the first layer, such as at least about 99% by weight of the first layer.

In some preferred embodiments, the first layer consists of COC (i.e. the first layer includes COC in an amount of 100% by weight of the first layer). It has been found that, where the COC is present as 100% by weight of the first layer, the water vapour transmission rate and oxygen transmission rate may be reduced compared to using lower amounts of the COC.

In some embodiments, the first layer comprises or consists of COC in an amount of at least about 5% by weight of the sum of components (i), (ii) and (iii). In some embodiments, the first layer comprises COC in an amount of from about 5% to about 80% by weight of the sum of components (i), (ii) and (iii). In some embodiments, the first layer comprises COC in an amount of from about 6% to about 70%, such as from about 7% to about 60%, such as from about 8% to about 50% by weight of the sum of components (i), (ii) and (iii). In some embodiments, the first layer comprises COC in an amount of from about 5% to about 50%, such as from about 6% to about 40%, such as from about 7% to about 30%, such as from about 8% to about 20%, such as from about 8% to about 15%, such as from about 8% to about 10%, such as approximately 8% by weight of the sum of components (i), (ii) and (iii). In some preferred embodiments, the first layer comprises COC in an amount of from about 5% to about 20%, more preferably from about 5% to about 15% by weight of the sum of components (i), (ii) and (iii). In each of these embodiments, the COC may be present in an amount of 100% by weight of the first layer (i.e. the first layer may consist of COC).

In some embodiments, the composition comprises the first layer in an amount of from about 5% to about 80% based on the total combined weight of layers (i), (ii) and (iii). In some embodiments, the composition comprises the first layer in an amount of from about 5% to about 60%, preferably in an amount of from about 5% to about 20%, more preferably in an amount of from about 5% to about 15%, and even more preferably in an amount of approximately 8% based on the total combined weight of layers (i), (ii) and (iii). In some embodiments, the composition comprises the first layer in an amount of approximately 5% based on the total combined weight of layers (i), (ii) and (iii).

It has been found that the inclusion of COC in the first layer provides a multi-layer film composition which has excellent barrier properties, whilst also having high bonding strengths and relatively low tear strengths allowing for packaging made from said film composition being relatively easy to manually tear open in a straight line. The COC in the first layer also allows for improved adhesion of the polyethylene in the second layer to any metal that may be included for metallisation of the composition. This improved adhesion may allow for a more consistent bond strength between the layers in the composition.

Additionally, it has been found that the inclusion of COC in the composition may result in a reduction in the tearing strength of the composition, which may result in a user being able to tear the composition in a straight line more easily. This is advantageous where the composition is used in packaging, which is generally to be opened by a user manually tearing the packaging.

### Second Layer

As described herein, the second layer in the multi-layer film composition comprises polyethylene (PE). Preferably, the second layer consists of PE.

The polyethylene included in the second layer may be any suitable type of polyethylene. In some embodiments, the polyethylene is selected from the group consisting of ultra-high-molecular-weight polyethylene (UHMWPE), ultra-low-molecular-weight polyethylene (ULMWPE), high-molecular-weight polyethylene (HMWPE), high-density polyethylene (HDPE), high-density cross-linked polyethylene (HDXLPE), cross-linked polyethylene (PEX), medium-density polyethylene (MDPE), linear low-density polyethylene (LLDPE), low-density polyethylene (LDPE), very-low-density polyethylene (VLDPE), chlorinated polyethylene (CPE), and combinations thereof.

In some preferred embodiments, the second layer comprises or consists of polyethylene where the polyethylene is selected from HDPE, LLDPE, LDPE, MDPE, and combinations thereof. Preferably, the second layer comprises or consists of polyethylene that is selected from HDPE, MDPE, LLDPE, or combinations thereof. Preferably, the second layer comprises or consists of polyethylene that is selected from MDPE, LLDPE, or combinations thereof. In some embodiments, the second layer comprises or consists of MDPE. In some embodiments, the second layer comprises or consists of LLDPE. In some embodiments, the second layer comprises or consists of LDPE. In some embodiments, the second layer comprises or consists of HDPE.

In some preferred embodiments, the second layer comprises or consists of polyethylene that is a combination of MDPE and LLDPE. The MDPE and LLDPE may be included in any suitable weight ratios. In some embodiments, the MDPE and LLDPE are included in the second layer in amounts such that the weight ratio of MDPE to LLDPE is from about 90:10 to about 10:90, preferably from about 70:30 to about 30:70, more preferably from about 60:40 to about 40:60.

In some embodiments, the second layer consists of HDPE, MDPE, LLDPE, LDPE or combinations thereof. Preferably, the second layer consists of MDPE. In other preferred embodiments, the second layer consists of LLDPE.

LDPE is a type of polyethylene that is typically defined by a density range of 0.91 to 0.925 g/cm³. LDPE may be produced using conventional processes known to one of skill in the art, such as a high pressure process via free radical polymerisation of ethylene. LLDPE is another form of low-density PE, and differs from LDPE in that it is typically substantially linear with a significant number of short branches but without significant amounts of long-chain branching. LLDPE typically has a density of 0.91 to 0.94 g/cm³. LLDPE is typically produced by copolymerisation of ethylene with longer-chain olefins, and via initiation with transition metal catalysts, such as Ziegler or Philips type of catalyst. MDPE typically has a density in the range of 0.926 to 0.94 g/cm³, and can be produced by chromium/silica catalyst, Ziegler-Natta catalyst or metallocene catalysts. HDPE typically has a density of greater than or equal to 0.941 g/cm³ and may typically be in the range of 0.94 to 0.97 g/cm³. HDPE typically has little branching which leads to stronger intermolecular forces and tensile strength than LDPE. HDPE may be produced by any conventional synthesis, for example using chromium/silica catalysts, Ziegler-Natta catalysts or metallocene catalysts.

In some embodiments, the polyethylene has a melt flow index of from about 1.5 g/10 min to about 3 g/10 min when measured at 190° C., 2.16 kg. Preferably, the polyethylene has a melt flow index of from about 1.5 g/10 min to about 2.5 g/10 min when measured at 190° C., 2.16 kg. Preferably, the polyethylene has a melt flow index of from about 2 g/10 min to about 2.5 g/10 min when measured at 190° C., 2.16 kg, and more preferably about 2.5 g/10 min when measured at 190° C., 2.16 kg. The melt flow index may be measured using test method ASTM D1238.

In some embodiments, the polyethylene has a density of from about 0.91 to about 0.97 g/cm³. In some preferred embodiments, the polyethylene has a density of from about 0.91 to 0.94 g/cm³, preferably from 0.915 to 0.935 g/cm³, more preferably from 0.92 to 0.935 g/cm³. The density may be measured by ASTM D792.

In some embodiments, the second layer is or comprises LLDPE Dow Dowlex™ 2036. LLDPE Dow Dowlex 2036 has a density of 0.935 g/cm³ and a melt flow index of 2.5 g/10 min when measured at 190° C., 2.16 kg.

In some embodiments, the second layer comprises polyethylene (such as HDPE, LLDPE and/or MDPE) in an amount of at least about 70% by weight of the second layer, such as at least about 80% by weight of the second layer, such as at least about 90% by weight of the second layer, such as at least about 95% by weight of the second layer, such as at least about 98% by weight of the second layer, such as at least about 99% by weight of the second layer. In some preferred embodiments, the second layer comprises polyethylene (such as HDPE, LLDPE and/or MDPE in an amount of from about 90% to about 99% by weight of the second layer. In some preferred embodiments, the second layer consists of polyethylene (such as HDPE, LLDPE and/or MDPE).

In some embodiments, the second layer comprises or consists of polyethylene (such as HDPE, LLDPE and/or MDPE) in an amount of at least 50% by weight of the sum of components (i), (ii) and (iii). In some embodiments, the second layer comprises polyethylene (such as HDPE, LLDPE and/or MDPE) in an amount of from about 50% to about 95% by weight of the sum of components (i), (ii) and (iii). Preferably, the second layer comprises polyethylene (such as HDPE, LLDPE and/or MDPE) in an amount of from about 60% to about 80%, more preferably from about 65% to about 75% by weight of the sum of components (i), (ii) and (iii), most preferably from about 67% to about 70% by weight of the sum of components (i), (ii) and (iii). In each of these embodiments, the polyethylene (such as HDPE, LLDPE and/or MDPE) may be present in an amount of from about 90% to about 100% by weight of the second layer, such as from about 90% to about 99% by weight of the second layer. Alternatively, in each of these embodiments, the polyethylene (such as HDPE, LLDPE and/or MDPE) may be present in an amount of 100% by weight of the second layer (i.e. the second layer may consist of polyethylene).

In some embodiments, the composition comprises the second layer in an amount of from about 30% to about 95% based on the total combined weight of layers (i), (ii) and (iii). In some embodiments, the composition comprises the second layer in an amount of from about 30% to about 90%, preferably in an amount of from about 60% to 80%, more preferably in an amount of from about 65% to about 75%, and even more preferably in an amount of about 67% by weight of the sum of components (i), (ii) and (iii).

It has been found that the inclusion of polyethylene in the second layer may improve the stiffness and machinability of the film composition.

In some embodiments, the second layer may further comprise additives or auxiliary agents. For example, the second layer may include anti-block additives or slip additives. In some embodiments, the second layer further comprises an anti-block additive. The slip additives or anti-block additives may be any suitable additives known in the art.

In some embodiments, the second layer comprises (a) polyethylene (such as LLDPE and/or MDPE in an amount of from about 90% to about 100% by weight of the second layer, and (b) an anti-block additive in an amount of from about 0% to 10% by weight of the second layer. In some embodiments, the second layer comprises (a) polyethylene (such as LLDPE and/or MDPE in an amount of from about 90% to about 99% by weight of the second layer, and (b) an anti-block additive in an amount of from about 1% to 5% by weight of the second layer.

### Third Layer

As described herein, the third layer in the multi-layer film composition comprises a polymer having a heat seal initiation temperature of no greater than about 170° C.

The polymer included in the third layer may be any suitable polymer having such a heat seal initiation temperature. The polymer in the third layer may thus provide an acceptable seal when relatively low temperatures are applied. The use of relatively low temperatures for forming the seal may be advantageous as this means that the first and second layers do not have to be heated to too high a temperature, which may adversely affect the properties of the polymers in the first and second layers (e.g. via thermal shrinkage or distortion). For example, the seal can be formed at temperatures that do not exceed 170° C., preferably may not exceed 150° C., and more preferably may not exceed 135° C. The seal may be formed at a temperature ranging from about 80 to about 150° C., such as from about 90 to about 140° C., and may thus not have an adverse impact on the properties of the first and second layers.

In some embodiments, the polymer having a heat seal initiation temperature of no greater than about 170° C. may be a polyolefin plastomer. As the skilled person understands, a plastomer is a polymer material that combines qualities of elastomers and plastics. Polyolefin plastomers (POPs) are typically ethylene-based or propylene-based random copolymers that may be produced from single-site catalysts. POPs may include ethylene or propylene monomers that are copolymerised with linear alpha-olefin monomers, such as propylene, ethylene, butene, hexane or octene. For example, an ethylene-based POP may include ethylene combined with linear alpha-olefin, such as butene, hexene or octene. A propylene-based POP may include propylene combined with ethylene or butene. POPs typically have a density in the range of from 0.886 to 0.912 g/cm³.

In some embodiments, the polymer having a heat seal initiation temperature of no greater than about 170° C. may be an ethylene-based polyolefin plastomer. The polyolefin plastomer may be a copolymer of ethylene and one or more of butene, hexene or octene. Preferably, the polyolefin plastomer may be a copolymer of ethylene and octene.

In some embodiments, the third layer comprises a polymer (preferably a polyolefin platomer) having a heat seal initiation temperature of no greater than about 150° C. In some embodiments, the third layer comprises a polymer (preferably a polyolefin platomer) having a heat seal initiation temperature of no greater than about 135° C. In some embodiments, the third layer comprises a polymer (preferably a polyolefin platomer) having a heat seal initiation temperature of no greater than about 125° C., preferably no greater than about 110° C., more preferably no greater than about 100° C., and even more preferably no greater than about 90° C. It may be advantageous if the polymer (such as a polyolefin plastomer) has a heat seal initiation temperature of no greater than about 85° C.

In some preferred embodiments, the third layer comprises a polymer (preferably a polyolefin plastomer) having a heat seal initiation temperature of no greater than about 110° C.

In some embodiments, the third layer comprises a polymer (preferably a polyolefin plastomer) having a heat seal initiation temperature of from about 50° ° C. to about 170° C., such as from about 50° C. to about 150° C., such as from about 60° C. to about 125° C., preferably from about 70° C. to about 110° C., more preferably from about 75° C. to about 100° C., and even more preferably from about 80° ° C. to about 90° C. In some embodiments, the third layer comprises a polymer (preferably a polyolefin plastomer) having a heat seal initiation temperature of from about 80° C. to about 110° C., and preferably from about 80° C. to about 100° C. It may be advantageous if the polymer (preferably a polyolefin plastomer) has a heat seal initiation temperature of approximately 85° C.

The third layer may comprise a polyolefin plastomer having a heat seal initiation temperature within any of the above-mentioned ranges, such as from about 80° ° C. to about 100° C.

In some embodiments, the polymer having a heat seal initiation temperature of no greater than about 170° C. (preferably a polyolefin plastomer) may have a melt flow index of from 0.5 to 3 g/10 min when measured at 190° C., 2.16 kg, preferably from about 1 to 2 g/10 min when measured at 190° C., 2.16 kg.

In some embodiments, the polymer having a heat seal initiation temperature of no greater than about 170° C. (preferably a polyolefin plastomer) has a coefficient of friction of from about 0.10 to about 0.25, and preferably from about 0.15 to about 2, and even more preferably approximately 0.15. The coefficient of friction may be measured by the standard ASTM D1894.

In some embodiments, the third layer comprises the polymer having a heat seal initiation temperature of no greater than about 170° C. (preferably a polyolefin plastomer) in an amount of at least about 50% by weight of the third layer, such as in an amount of at least about 60% by weight of the third layer, such as in an amount of at least about 70% by weight of the third layer, such as at least about 80% by weight of the third layer, such as at least about 90% by weight of the third layer, such as at least about 99% by weight of the third layer. In some embodiments, the third layer may consist of polymer having a heat seal initiation temperature of no greater than about 170° C. (preferably a polyolefin plastomer).

In some embodiments, the third layer comprises the polymer having a heat seal initiation temperature of no greater than about 170° C. (preferably a polyolefin plastomer) in an amount of from about 50% to about 99% by weight of the third layer, such as from about 60% to about 95% by weight of the third layer, such from about 70% to about 90% by weight of the third layer, such as from about 70% to about 80% by weight of the third layer. Preferably, the third layer comprises a polyolefin plastomer in an amount of from about 60% to about 80% by weight of the third layer. Preferably, the third layer comprises a polyolefin plastomer in an amount of from about 70% to about 80% by weight of the third layer.

In some preferred embodiments, the third layer comprises the polymer having a heat seal initiation temperature of no greater than about 170° C. (preferably a polyolefin plastomer) in an amount of from about 70% to about 80% by weight of the third layer. In some embodiments, the third layer comprises a polyolefin plastomer in an amount of from about 70% to about 80% by weight of the third layer.

In some embodiments, the third layer comprises a polymer having a heat seal initiation temperature of no greater than about 170° C. in an amount of from about 15% to about 30% by weight of the sum of components (i), (ii) and (iii). Preferably, the third layer comprises a polymer having a heat seal initiation temperature of no greater than about 170° C. in an amount of from about 15% to about 25% by weight of the sum of components (i), (ii) and (iii). In some embodiments, the third layer comprises a polyolefin plastomer in an amount of from about 15% to about 30% by weight of the sum of components (i), (ii) and (iii), preferably in an amount of from about 15% to about 25% by weight of the sum of components (i), (ii) and (iii). In some embodiments, the third layer comprises a copolymer of ethylene and octene in an amount of from about 15% to about 30% by weight of the sum of components (i), (ii) and (iii), preferably in an amount of from about 15% to about 25% by weight of the sum of components (i), (ii) and (iii).

Preferably, the polymer having the requisite heat seal initiation temperature may be combined with an additional polymer in the third layer. The additional polymer may be any suitable polymer that allows for an acceptable seal to be formed by the third layer. It may be preferred for the purposes of recyclability for the additional polymer to be a type of polyethylene. It has also been found that the inclusion of polyethylene eases process flow. The additional polymer (such as PE) may preferably have a melt flow index of from about 1.5 g/10 min to about 3 g/10 min when measured at 190° C., 2.16 kg. Preferably, the polyethylene has a melt flow index of from about 2 g/10 min to about 2.5 g/10 min when measured at 190° C., 2.16 kg, and more preferably about 2.5 g/10 min when measured at 190° ° C., 2.16 kg.

In some embodiments, the additional polymer may be any suitable type of polyethylene. In some embodiments, the additional polymer is selected from the group consisting of ultra-high-molecular-weight polyethylene (UHMWPE), ultra-low-molecular-weight polyethylene (ULMWPE), high-molecular-weight polyethylene (HMWPE), high-density polyethylene (HDPE), high-density cross-linked polyethylene (HDXLPE), cross-linked polyethylene (PEX), medium-density polyethylene (MDPE), linear low-density polyethylene (LLDPE), low-density polyethylene (LDPE), very-low-density polyethylene (VLDPE), chlorinated polyethylene (CPE), and combinations thereof. Preferably, the additional polymer is selected from the group consisting of MDPE, LLDPE, LDPE, and combinations thereof. Preferably, the additional polymer is or comprises LDPE. Preferably, the additional polymer is LDPE.

Therefore, in some embodiments, the third layer comprises a polyolefin plastomer, optionally in combination with a low-density polyethylene. In some embodiments, the third layer comprises a polyolefin plastomer, optionally in combination with a linear low-density polyethylene.

In some embodiments, the additional polymer (such as LDPE) is present in an amount of from about 1% to about 50% by weight of the third layer, such as from about 5% to about 40% by weight of the third layer, such as from about 10% to about 30% by weight of the third layer. It may be preferred for the additional polymer (such as LDPE) to be present in an amount of from about 20% to about 40% by weight of the third layer. It may be preferred for the additional polymer (such as LDPE) to be present in an amount of from about 20% to about 30% by weight of the third layer. Preferably, the third layer comprises LDPE in an amount of from about 20% to about 30% by weight of the third layer.

In some embodiments, the third layer comprises polyethylene (such as LDPE) in an amount of from about 1% to about 15% by weight of the sum of components (i), (ii) and (iii). Preferably, the third layer comprises polyethylene (such as LDPE) in an amount of from 2.5% to 10%, more preferably from 4% to 10% by weight of the sum of components (i), (ii) and (iii).

In some embodiments, the third layer comprises (a) a polyolefin plastomer in an amount of from about 60% to 95% by weight of the third layer, and (b) low-density polyethylene in an amount of from about 5% to about 40% by weight of the third layer. In some embodiments, the third layer comprises (a) a polyolefin plastomer in an amount of from about 70% to 85% by weight of the third layer, and (b) low-density polyethylene in an amount of from about 15% to about 30% by weight of the third layer. In some embodiments, the third layer comprises (a) a polyolefin plastomer in an amount of from about 70% to 80% by weight of the third layer, and (b) low-density polyethylene in an amount of from about 20% to about 30% by weight of the third layer.

In some embodiments, the weight ratio of the polymer having a heat seal initiation temperature of no greater than about 170° C. (preferably a polyolefin plastomer, such as a copolymer of ethylene and octene) to the additional polymer (preferably LDPE) is from about 99:1 to about 50:50, preferably from about 90:10 to about 60:40, and more preferably from about 80:20 to about 70:30.

In some embodiments, the composition comprises the third layer in an amount of from about 5% to about 80% based on the total combined weight of layers (i), (ii) and (iii), such as in an amount of from about 10% to about 50% based on the total combined weight of layers (i), (ii) and (iii). In some embodiments, the composition comprises the third layer in an amount of from about 5% to about 65% based on the total combined weight of layers (i), (ii) and (iii), preferably in an amount of from about 15% to about 35%, and more preferably in an amount of from about 20% to about 30% by weight of the sum of components (i), (ii) and (iii).

It has been found that the inclusion of a third layer including such polymers as described hereinabove may provide the film composition with improved sealing properties and decreased leakage of the contents from within packaging formed by the film. Where the amount of the third layer is low (e.g. less than 20%), the seal formed may not be as strong as where higher amounts of the third layer are included. By providing a third ‘sealing’ layer having a polymer with a relatively low heat seal initiation temperature, the present inventors found that an excellent seal could be formed by heating the composition but without adversely impacting the properties of the first and second layers. The seal range and seal integrity may thus be improved.

The third layer may provide the composition with a high seal strength. The seal strength may be greater than about 1N/15 mm, and preferably greater than about 5 N/15 mm. In some embodiments, the seal strength of the composition may be from about 1 N/15 mm to about 40 N/15 mm, preferably from about 5 N/15 mm to about 30 N/15 mm, preferably from about 5 N/15 mm to about 20 N/15 mm, more preferably from about 10 N/15 mm to about 15 N/15 mm. In some embodiments, the seal strength may be from about 10 N/15 mm to about 14 N/15 mm.

In some embodiments, the third layer may further comprise additives or auxiliary agents. For example, the third layer may include anti-block additives or slip additives. In some embodiments, the third layer further comprises an anti-block additive.

In some embodiments, the third layer comprises (a) a polyolefin plastomer in an amount of from about 70% to 85% by weight of the third layer, (b) low-density polyethylene in an amount of from about 15% to about 30% by weight of the third layer, and (c) an anti-block additive in an amount of from about 0% to 5% by weight of the third layer. In some embodiments, the third layer comprises (a) a polyolefin plastomer in an amount of from about 70% to 80% by weight of the third layer, (b) low-density polyethylene in an amount of from about 15% to about 25% by weight of the third layer, and (c) an anti-block additive in an amount of from about 1% to about 3% by weight of the third layer.

In some embodiments, the third layer may further comprise additives or auxiliary agents. For example, the third layer may include anti-block additives or slip additives. In some embodiments, the third layer further comprises an anti-block additive. The slip additives or anti-block additives may be any suitable additives known in the art. For example, Slipblock from additive supplier, Amphacet, may be used in the third layer to maintain the coefficient of friction for the PE film.

### Arrangement of First, Second and Third Layers

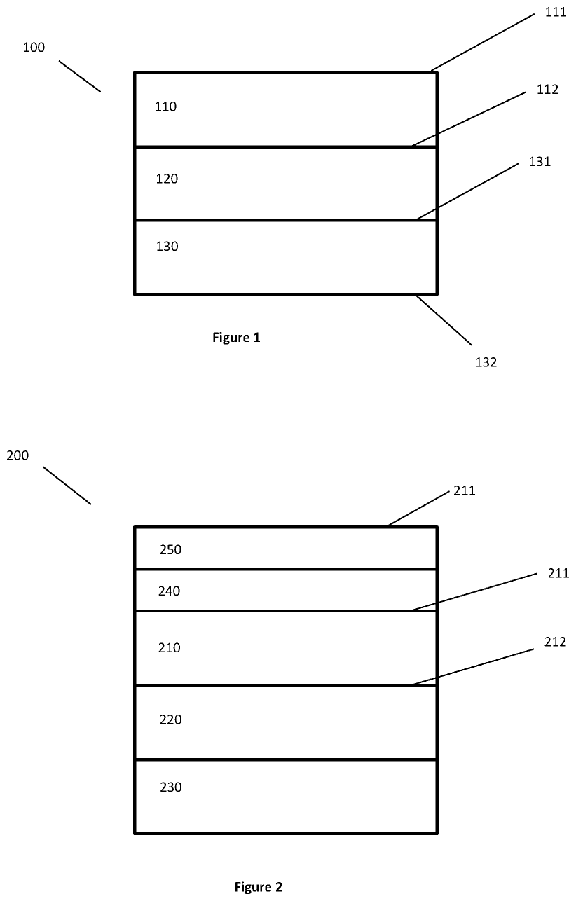

As described herein, the second layer is positioned between the first and third layers. FIG. 1 shows an embodiment of the multi-layer film composition 100. As shown in FIG. 1, the first layer 110 is in contact with the second layer 120, which is in turn in contact with the third layer 130. In some embodiments, the second layer may be considered to be a core layer found sandwiched between the first and third layers.

As shown in FIG. 1, the third layer 130 has a first surface 131 that is in contact with the second layer 120 and a second surface 132 that may act as an external surface of the multi-layer film composition. The third layer may preferably be referred to as a ‘sealant’ layer, which is capable of forming a seal and reducing permeability of materials through the film composition. Where the film composition acts as packaging to contain a liquid or solid material, the third layer may reduce leakage of said material by virtue of its sealing effect.

The first layer 110 may also have a first surface 111 and a second surface 112, where the second surface 112 may be in contact with the second layer 120 and the first surface 111 may not be in contact with the second layer 120 (or the third layer 130).

The multi-layer composition may comprise the layers in the following relative amounts:
(i) the first layer in an amount of from about 5% to about 60% based on the total combined weight of layers (i), (ii) and (iii);
(ii) the second layer in an amount of from about 30% to about 90% based on the total combined weight of layers (i), (ii) and (iii); and
(iii) the third layer in an amount of from about 5% to about 65% based on the total combined weight of layers (i), (ii) and (iii).

The multi-layer composition may comprise the layers in the following relative amounts:
(iv) the first layer in an amount of from about 5% to about 20% based on the total combined weight of layers (i), (ii) and (iii);
(v) the second layer in an amount of from about 60% to about 80% based on the total combined weight of layers (i), (ii) and (iii); and
(vi) the third layer in an amount of from about 15% to about 35% based on the total combined weight of layers (i), (ii) and (iii).

In some embodiments, the multi-layer composition comprises the layers in the following relative amounts:
(i) the first layer in an amount of from about 5% to about 15% based on the total combined weight of layers (i), (ii) and (iii);
(ii) the second layer in an amount of from about 65% to about 75% based on the total combined weight of layers (i), (ii) and (iii); and
(iii) the third layer in an amount of from about 20% to about 30% based on the total combined weight of layers (i), (ii) and (iii).

In some embodiments, the first and second layers are present in a weight ratio of from about 1:20 to about 1:2, such as from about 1:15 to about 1:5, such as from about 1:10 to about 1:5.

In some embodiments, the first and third layers are present in a weight ratio of from about 1:1 to about 1:10, such as from about 1:1.5 to about 1:7.5, such as from about 1:2 to about 1:5.

In some embodiments, the second and third layers are present in a weight ratio of from about 2:1 to about 1:10, such as from about 1:1 to about 1:5, such as from about 1:2 to about 1:4.

In some embodiments, the multi-layer composition has a thickness of from about 1 μm to about 100 μm. In some embodiments, the multi-layer composition has a thickness of from about 10 μm to about 90 μm. The thickness of the multi-layer composition may vary depending on the intended use of the composition. Where the composition is to be used in single-use packaging (i.e. packaging that contains a single serving of a product and thus will only be opened once and then discarded after a single use), the thickness of the composition may be from about 15 μm to about 50 μm, and preferably from about 20 μm to about 40 μm. Where the composition is to be used in multi-use packaging (i.e. packaging that contains multiple servings of a product and thus may be resealed in some way after one serving has been taken from the packaging), the thickness of the composition may be from about 20 μm to about 90 μm, and preferably from about 35 μm to about 80 μm.

The relative thickness of the first to second to third layers in the composition may be from 1:2:1 to about 1:20:2, such as from about 1:5:1 to about 1:10:2.

Preferably, the multi-layer film composition comprises the layers in the following relative amounts:
(i) a first layer consisting of a cyclic olefin copolymer, the first layer being present in an amount of from about 5% to about 15% based on the total combined weight of layers (i), (ii) and (iii);
(ii) a second layer comprising LLDPE, MDPE or combinations thereof, the second layer being present in an amount of from about 65% to about 75% based on the total combined weight of layers (i), (ii) and (iii); and
(iii) a third layer comprising 70-80% of a polyolefin plastomer based on the weight of the third layer and 20-30% of a polyethylene (preferably LDPE) based on the weight of the third layer, the third layer being present in an amount of from about 20% to about 30% based on the total combined weight of layers (i), (ii) and (iii).

Preferably, the multi-layer film composition comprises the layers in the following relative amounts:
(i) a first layer consisting of a cyclic olefin copolymer, the first layer being present in an amount of from about 5% to about 8% based on the total combined weight of layers (i), (ii) and (iii);
(ii) a second layer comprising LLDPE, MDPE or combinations thereof, the second layer being present in an amount of from about 67% to about 70% based on the total combined weight of layers (i), (ii) and (iii); and
(iii) a third layer comprising 70-80% of a polyolefin plastomer based on the weight of the third layer and 20-30% of a polyethylene (preferably LDPE) based on the weight of the third layer, the third layer being present in an amount of about 25% based on the total combined weight of layers (i), (ii) and (iii).

Such a multi-layer film composition may also further comprise a metal layer in contact with the first layer, and optionally an external printable layer comprising OPP.

### Further Components

In some embodiments, the multi-layer film composition consists of the first, second and third layers as described hereinabove.

Alternatively, the multi-layer composition may further comprise additional layers and/or additional components. In some embodiments, the multi-layer composition further comprises a metal layer. The metal layer may preferably be included in contact with the first layer such that the first layer is positioned between the metal layer and the second layer. This arrangement is shown in FIG. 2, where the first layer 210 of the multi-layer composition 200 has a first surface 211 and a second surface 212, and where the first surface 211 is in contact with the metal layer 240. The multi-layer composition 200 also comprises a second layer 220 and a third layer 230 in the same configuration as shown in FIG. 1. Multi-layer compositions including a metal layer may be referred to herein as a “metallised film composition”.

In some embodiments, the metal layer may be made of any suitable metal known in the art to provide acceptable barrier properties. In some embodiments, the metal layer consists of or comprises aluminium. Preferably, the metal layer consists of aluminium.

The inclusion of the metal layer such that the film composition is a metallised film composition may further improve the barrier properties of the composition. It was also surprisingly found by the present inventors that the inclusion of the first layer between the second layer and the metal layer may enhance the adhesion of the polyethylene to the metal layer. Metallised polyethylene films have previously suffered from poor adhesion properties between a PE layer and the metal, while in the present invention the adhesion was improved, allowing for a more consistent bond strength. The consistency in bond strength allows for coefficient of friction of the film composition to be adjusted or optimised, and for the deposition amount of the metal layer to be optimised thus further improving the barrier properties. In some embodiments, the metallised polyethylene film may have a water vapour transmission rate and/or oxygen transmission as described hereinabove. Each of the ranges noted above for the WVTR and/or OTR equally apply for the metallised polyethylene film. For example, the metallised multi-layer film composition preferably has an OTR of no greater than about 3 cc/m² per day. For example, the metallised multi-layer film composition may preferably have a WVTR of no greater than about 0.1 g/m² per day. The OTR may be measured at 23° C. and 50% RH using ASTM F1927 or at 23° C. and 0% RH using ASTM D3985, and the WTR may be measured using ASTM F1249 at 38° C. and 90% RH.

In some embodiments in which the composition comprises a metal layer, the coefficient of friction between the first layer and the metal layer of from about 0.01 to about 1, preferably from about 0.1 to about 0.5, more preferably from about 0.15 to about 0.4, and even more preferably from about 0.2 to about 0.3. The coefficient of friction between the first layer and the metal layer may preferably be from about 0.1 to about 0.25.

The multi-layer composition may further comprise an external printable layer. This printable layer may be made of any suitable material that allows for an image or text to be printed thereon and which will be visible to the user of the multi-layer film composition. For example, where the composition is intended for use in packaging, the printable layer may include a design and/or text printed thereon which is visible to the user and provides information to the user relating to the contents within the packaging. The external printable layer may be included with or without the inclusion of the metal layer described above. In some embodiments, the multi-layer composition comprises both a metal layer as described above and an external printable layer. Such an arrangement is depicted in FIG. 2, in which the external printable layer 250 is arranged such that it is adjacent to the metal layer 240. The external printable layer has at least one surface 251 that is not in contact with any other layers such that any design printed thereon can be viewed by the user of the composition.

In some embodiments, the external printable layer comprises a polymer selected from oriented polypropylene (OPP), oriented polyethylene (OPE) and combinations thereof. In some embodiments, the external printable layer comprises oriented polypropylene. In some embodiments, the external printable layer comprises oriented polyethylene. The OPP and/or OPE may be any commercially available grade of OPP and/or OPE having a printing grade for food packaging or the like. Preferably, the polymer is OPP. It has been found that, when OPP is used as the external printable layer, the barrier properties may be improved compared with other printable materials (e.g. polyethylene terephthalate, PET).

In some embodiments, the external printable layer included in the composition has a thickness of from about 15 μm to about 50 μm, such as from about 15 μm to about 45 μm.

In some embodiments, the external printable layer comprises OPP and has a thickness of from about 15 μm to about 50 μm, and preferably about 30 μm. Where the composition is to be used in single-use packaging, the thickness of the external printable layer comprising OPP may be from about 15 μm to about 40 μm, and preferably from about 20 μm to about 35 μm. Where the composition is to be used in multi-use packaging, the thickness of the external printable layer comprising OPP may be from about 30 μm to about 50 μm.

In some embodiments, the external printable layer comprises OPE and has a thickness of from about 20 μm to about 45 μm, and preferably about 25 μm. In some embodiments, the composition may be intended for use in single-use packaging, and the thickness of the external printable layer comprising OPE may be from about 20 μm to about 40 μm, and preferably from about 20 μm to about 30 μm. In some embodiments, the composition may be intended for use in multi-use packaging, and the thickness of the external printable layer comprising OPE may be from about 30 μm to about 50 μm.

In some embodiments, the external printable layer may be present in the composition such that the ratio of thickness of the external printable layer to the total combined thickness of layers (i), (ii) and (iii) is in the range of from 10:1 to 1:10. Preferably, the ratio of thickness of the external printable layer to the total combined thickness of layers (i), (ii) and (iii) is from about 2:1 to about 1:5, such as from about 1:1 to about 1:3, such as from about 1:1 to about 1:2.

In addition to providing a suitable printing surface, the external printable layer may improve the stiffness of the composition so as to improve the machinability of the composition.

In some embodiments, the film comprising an external printable layer (with or without a metal layer) may have a water vapour transmission rate and/or oxygen transmission as described hereinabove. Each of the ranges noted above for the WVTR and/or OTR equally apply for the film comprising an external printable layer. For example, the metallised multi-layer film composition preferably has an OTR of no greater than about 3 cc/m² per day. For example, the metallised multi-layer film composition may preferably have a WVTR of no greater than about 0.1 g/m² per day. The OTR may be measured at 23° C. and 50% RH using ASTM F1927, and the WVTR may be measured using ASTM F1249 at 38° C. and 90% RH.

Where both a metal layer and an external printable layer are present, the coefficient of friction between the metal layer and the external printable layer may be from about 0.1 to about 0.5, and preferably from about 0.2 to about 0.4.

In some embodiments, the multi-layer film composition comprises:
(i) a first layer comprising a cyclic olefin copolymer;
(ii) a second layer comprising polyethylene; and
(iii) a third layer comprising a polymer having a heat seal initiation temperature of no greater than about 170° C.;
wherein the second layer is positioned between the first and third layers,
(iv) a metal layer; and
(v) an external printable layer.

In such embodiments, the metal layer may preferably be positioned between the first layer and the external printable layer.

### Total Composition

The multi-layer film composition described herein is preferably a cast film. Due to the inclusion of the polyethylene in at least the second layer, the film composition may be referred to as a cast polyethylene film (CPE). Where the film composition includes a metal layer, the film composition may be a metallised cast polyethylene film (MCPE).

In some embodiments, the multi-layer film composition has an oxygen transmission rate (OTR) of no greater than about 5 cc/m² per day, such as no greater than about 3 cc/m² per day. Preferably the multi-layer film composition has an OTR of no greater than about 3 cc/m² per day. It is especially preferred if the oxygen transmission rate is no greater than about 1 cc/m² per day, such as no greater than about 0.75 cc/m² per day, such as no greater than about 0.5 cc/m² per day. In some preferred embodiments, the multi-layer film composition has an oxygen transmission rate (OTR) of no greater than about 0.2 cc/m² per day. In some preferred embodiments, the multi-layer film composition has an oxygen transmission rate (OTR) of no greater than about 0.1 cc/m² per day. The multi-layer film composition may have an oxygen transmission rate of from about 0.01 to about 5 cc/m² per day, such as from about 0.1 to about 3 cc/m² per day. The oxygen transmission rate is a measure of the steady state rate at which oxygen gas can permeate through a film. The oxygen transmission rate may be measured at 23° C. and 0% RH or 50% RH using ASTM D3985 or ASTM F1927, respectively.

In some embodiments, the multi-layer film composition has a water vapour transmission rate of no greater than about 1 g/m² per day. In preferred embodiments, the multi-layer film composition has a water vapour transmission rate of no greater than about 0.5 g/m² per day. In some preferred embodiments, the multi-layer film composition has a water vapour transmission rate of no greater than about 0.2 g/m² per day. Preferably, the multi-layer film composition has a water vapour transmission rate of no greater than about 0.1 g/m² per day. More preferably, the multi-layer film composition has a water vapour transmission rate of no greater than about 0.05 g/m² per day. The multi-layer film composition may have a water vapour transmission rate of from about 0.0001 to about 0.1 g/m² per day, such as from about 0.001 to about 0.05 g/m² per day, such as from about 0.01 to about 0.075 g/m² per day. Similar to the OTR, the water vapour transmission rate (WVTR) is a measure of the steady state rate at which water vapour can permeate through a film. The WTR may be measured using ASTM F1249 at 38° C., 90% RH.

In preferred embodiments, the multi-layer film composition has a water vapour transmission rate of no greater than about 0.1 g/m² per day.

Oxygen gas and water vapour are both gases that are known to affect the microbial stability of food and drink products, e.g. coffee, tea, chocolate, cheese, meat, nuts and the like. The present inventors have found that the combination of the COC in the first layer of the composition with the second and third layers provides for a film that has excellent barrier properties with respect to both oxygen and water vapour. This means that the rate at which oxygen gas and/or water vapour is capable of permeating the film is low such that the shelf-life of materials stored within packaging formed by the film may be improved.

As noted hereinabove, it has also been found that the composition may have low tear strength such that the composition may be smoothly and manually torn in a straight line. In some embodiments, the tear strength of the multi-layer composition may be no greater than about 4 N, such as no greater than about 3 N, and preferably no greater than about 2 N.

It has also been found that the composition provides an advantageous coefficient of friction between the external surface of the third layer (or sealant layer) to the processing machine. It was previously found that metallised PE films may have a very high friction and thus not meet filling machine requirements. However, the present invention has been found to alleviate these issues.

Additionally, it has been found that the composition provides for a wider seal range with validated seal integrity to ensure package tightness with a good seal appearance.

In some embodiments, the multi-layer film composition comprises:
(i) a first layer comprising a cyclic olefin copolymer;
(ii) a second layer comprising polyethylene; and
(iii) a third layer comprising a polymer having a heat seal initiation temperature of no greater than about 170° C.;
   wherein the second layer is positioned between the first and third layers,
   and said multi-layer film composition has an oxygen transmission rate of no greater than about 3 g/m² per day and/or said multi-layer film composition has a water vapour transmission rate of no greater than about 0.5 g/m² per day.

In some embodiments, the multi-layer film composition comprises:
(i) a first layer comprising a cyclic olefin copolymer;
(ii) a second layer comprising polyethylene; and
(iii) a third layer comprising a polymer having a heat seal initiation temperature of no greater than about 170° C.;
   wherein the second layer is positioned between the first and third layers,
   and said multi-layer film composition has an oxygen transmission rate of no greater than about 3 g/m² per day and/or said multi-layer film composition has a water vapour transmission rate of no greater than about 0.1 g/m² per day.

In some embodiments, the multi-layer film composition comprises:
(i) a first layer comprising a cyclic olefin copolymer;
(ii) a second layer comprising polyethylene; and
(iii) a third layer comprising a polymer having a heat seal initiation temperature of no greater than about 170° C.;
   wherein the second layer is positioned between the first and third layers, and said multi-layer film composition has an oxygen transmission rate of no greater than about 0.5 g/m² per day.

In some embodiments, the multi-layer film composition comprises:
(i) a first layer comprising a cyclic olefin copolymer;
(ii) a second layer comprising polyethylene; and
(iii) a third layer comprising a polymer having a heat seal initiation temperature of no greater than about 170° C.;
wherein the second layer is positioned between the first and third layers,
(iv) a metal layer; and
(v) an external printable layer, preferably comprising oriented polypropylene, oriented polyethylene or combinations thereof;
   and said multi-layer film composition has an oxygen transmission rate of no greater than about 3 g/m² per day and/or said multi-layer film composition has a water vapour transmission rate of no greater than about 0.1 g/m² per day. The metal layer may preferably be positioned between the first layer and the external printable layer.

In some preferred embodiments, the multi-layer film composition comprises:
(i) a first layer consisting of a cyclic olefin copolymer;
(ii) a second layer comprising polyethylene; and
(iii) a third layer comprising a polymer having a heat seal initiation temperature of no greater than about 150° C.;
wherein the second layer is positioned between the first and third layers;
(iv) a metal layer; and
(v) an external printable layer, preferably comprising oriented polypropylene, oriented polyethylene or combinations thereof.

In some preferred embodiments, the multi-layer film composition comprises:
(i) a first layer consisting of a cyclic olefin copolymer, wherein the first layer is present in an amount of from about 5% to about 15% based on the total combined weight of layers (i), (ii) and (iii);
(ii) a second layer comprising LLDPE, MDPE or combinations thereof, the second layer being present in an amount of from about 65% to about 75% based on the total combined weight of layers (i), (ii) and (iii); and
(iii) a third layer comprising 70-80% of a polyolefin plastomer based on the weight of the third layer and 20-30% of a polyethylene (preferably LDPE) based on the weight of the third layer, the third layer being present in an amount of from about 20% to about 30% based on the total combined weight of layers (i), (ii) and (iii);
wherein the second layer is positioned between the first and third layers;
(iv) a metal layer; and
(v) an external printable layer, preferably comprising oriented polypropylene, oriented polyethylene or combinations thereof.

### Laminate

Also described herein is a laminate comprising:
(a) a first barrier layer comprising a metallised multi-layer film composition as described hereinabove;
(b) a second barrier layer comprising metallised oriented polypropylene; and
(c) an external printable layer comprising a polymer selected from oriented polypropylene, oriented polyethylene and combinations thereof.

The first barrier layer may be a metallised multi-layer film composition having any of the features and/or properties as described above. The first barrier layer may thus be a metallised cast polyethylene film (MCPE) including COC in a first layer, PE in a second layer and a polymer having a heat seal initiation temperature of no greater than about 170° C. in a third layer. The first barrier layer may also act as a sealant layer.

In some embodiments, the first barrier layer is present in an amount of from about 10% to about 90% by volume of the laminate. In some embodiments, the first barrier layer is present in an amount of from about 15% to about 70% by volume of the laminate. In some preferred embodiments, the first barrier layer is present in an amount of from about 20% to about 60% by volume of the laminate, and preferably from about 30% to about 50% by volume of the laminate. As used herein, “% by volume” is the percentage by volume per unit area of the laminate.

In some embodiments (e.g. where the packaging may be used as a single serve packaging), the first barrier layer is present in an amount of from about 15% to about 40% by volume of the laminate, preferably from about 15% to about 30% by volume of the laminate. In some embodiments (e.g. where the packaging may be used as a multi serve packaging), the first barrier layer is present in an amount of from about 20% to about 70% by volume of the laminate, preferably from about 25% to about 50% by volume of the laminate.

In some embodiments, the second barrier layer is present in an amount of from about 1% to about 40% by volume of the laminate. In some embodiments, the second barrier layer is present in an amount of from about 5% to about 30% by volume of the laminate, and preferably from about 10% to about 25% by volume of the laminate. In some embodiments (e.g. where the packaging may be used as a single serve packaging), the second barrier layer is present in an amount of from about 10% to about 40% by volume of the laminate, preferably from about 15% to about 35% by volume of the laminate. In some embodiments (e.g. where the packaging may be used as a multi serve packaging), the second barrier layer is present in an amount of from about 1% to about 30% by volume of the laminate, preferably from about 5% to about 25% by volume of the laminate.

As for the multi-layer film composition, the external printable layer in the laminate may be present to provide a printing substrate for packaging prepared from the laminate. The external printable layer may also improve the stiffness and machinability of the laminate. The external printable layer comprises a polymer selected from oriented polypropylene, oriented polyethylene and combinations thereof. Preferably, the external printable layer comprises OPP.

In some embodiments, the external printable layer is present in an amount of from about 1% to about 80% by volume of the laminate. In some embodiments, the external printable layer is present in an amount of from about 5% to about 60% by volume of the laminate. In some preferred embodiments, the external printable layer is present in an amount of from about 10% to about 50% by volume of the laminate, and preferably from about 15% to about 30% by volume of the laminate. In some embodiments (e.g. where the packaging may be used as a single serve packaging), the external printable layer is present in an amount of from about 5% to about 80% by volume of the laminate, preferably from about 10% to about 60% by volume of the laminate. In some embodiments (e.g. where the packaging may be used as a multi serve packaging), the external printable layer is present in an amount of from about 1% to about 60% by volume of the laminate, preferably from about 5% to about 40% by volume of the laminate, more preferably from about 10% to about 30% by volume of the laminate.

In some embodiments, the laminate comprises:
(a) a first barrier layer comprising a metallised multi-layer film composition as described hereinabove, the first barrier layer being present in an amount of from about 30% to about 50% by volume of the laminate;
(b) a second barrier layer comprising metallised oriented polypropylene, the second barrier layer being present in an amount of from about 10% to about 25% by volume of the laminate; and
(c) an external printable layer comprising a polymer selected from oriented polypropylene, oriented polyethylene and combinations thereof, the external printable layer being present in an amount of from about 15% to about 30% by volume of the laminate.

The laminate may have a total thickness of from about 40 μm to about 200 μm, preferably from about 50 μm to about 150 μm, and more preferably from about 60 μm to about 100 μm. In some preferred embodiments, the laminate has a total thickness of from about 50 μm to about 200 μm.

The thickness of the first barrier material may be from about 20 μm to about 80 μm, and preferably from about 20 μm to about 40 μm. The thickness of the second barrier material may be from about 5 μm to about 25 μm, and preferably from about 15 μm to about 20 μm. In some preferred embodiments, the thickness of the first barrier layer is from about 20 μm to about 80 μm, and the thickness of the second barrier layer is from about 5 μm to about 20 μm. The thickness of the external printable layer may be from about 15 μm to about 45 μm, and preferably from about 15 μm to about 25 μm.

In some embodiments, the laminate comprises the following:
(a) the first barrier layer having a thickness of about 35 μm;
(b) the second barrier layer having a thickness of from about 16 μm to about 18 μm; and
(c) the external printable layer having a thickness of from about 18 μm to about 20 μm.

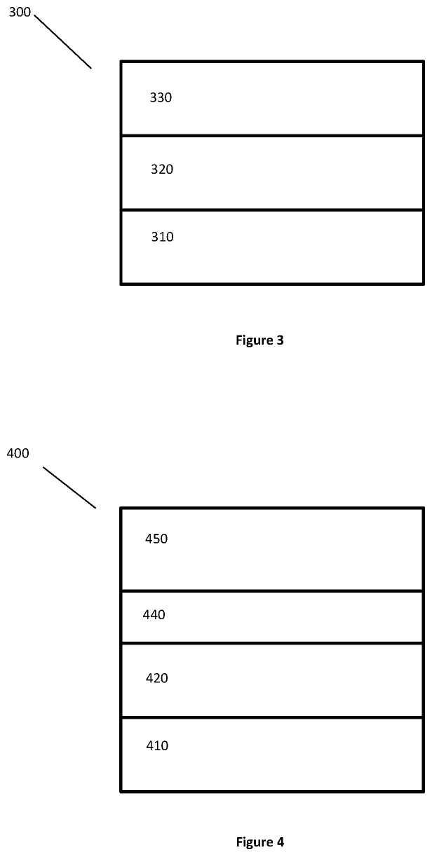

As shown in FIG. 3, the second barrier layer 320 in the laminate 300 is preferably positioned between the first barrier layer 310 and the external printable layer 330 such that the first barrier layer 310 may act as a sealant layer.

The laminate may optionally include an additional layer comprising polyethylene. The additional layer may be positioned anywhere in the laminate, but is preferably positioned between the second barrier layer and the external printable layer. This is shown in FIG. 4, where the laminate 400 includes a first barrier layer 410 adjacent to a second barrier layer 420, which in turn is adjacent to an additional layer 440 comprising polyethylene, which in turn is adjacent to the external printable layer 430.

Where an additional layer is included, the polyethylene may be any suitable ethylene, such as HDPE, MDPE, LLDPE, LDPE, and combinations thereof. The polyethylene may preferably be extruded polyethylene. The additional layer may act as a tie layer adhering the external printable layer to the second barrier layer, and may also act as an intermediate layer to increase the space available for laser coding.

Where an additional layer is included, the additional layer may be present in an amount of from about 1% to about 30% by volume of the laminate, such as from about 5% to about 25% by volume of the laminate. In some preferred embodiments, the additional layer may be included in an amount of from about 10% to about 20% by volume of the laminate.

An additional primer may be included between the external printable layer and the additional layer comprising polyethylene in order to improve adhesion of the external printable layer to the polyethylene. The primer may be any commercially available primer, such as a diluted adhesive.

In some embodiments, an adhesive layer may also be included between any of the aforementioned layers in order to improve adhesion between the layers. For example, an adhesive layer may be included between the first and second barrier layers. Any suitable adhesive may be used. For example, the adhesive may be a solvent-free or solvent-based polyurethane, polyether or acrylic based adhesive.

The laminate may be printed upon using an ink material. The ink may be a multiple colour ink suitable for printing on an OPP or OPE film. Suitable inks will be apparent to those of skill in the art. The ink may be applied in an amount of from 0 g/m² to about 4 g/m² on the laminate.

The laminate may be useful for providing extra-high barrier properties for packaging that is suitable for use in storing food products that are particularly sensitive to oxygen and moisture; e.g. freeze-dried coffee products or ground coffee beans. It has been found that the laminate may be able to maintain the water activity (Aw) of the food product within the range of 0.01 to 0.5 for periods of up to 18 months, and preferably for a period of between 12-18 months. For example, the water activity of the food product (e.g. coffee) stored in the laminate packaging may be from about less than about 0.4, such as less than about 0.25 for periods of up to 18 months, and may preferably be in the range of from about 0.1 to about 0.25. The water activity of the food product (e.g. coffee) stored in the laminate packaging may be from about less than about 0.4, such as less than about 0.25 for periods of up to 12 months, and may preferably be in the range of from about 0.1 to about 0.25.

In particular, it has been found that the combination of two high barrier metallised polyolefin films may further improve the barrier properties. The laminate may have a water vapour transmission rate (WVTR) of no greater than about 0.5 g/m² per day, such as no greater than about 0.2 g/m² per day. In some preferred embodiments, the laminate has a water vapour transmission rate of no greater than about 0.1 g/m² per day. Preferably, the laminate has a water vapour transmission rate of no greater than about 0.05 g/m² per day, and more preferably no greater than about 0.02 g/m² per day. More preferably, the multi-layer film composition has a water vapour transmission rate of no greater than about 0.01 g/m² per day.

In some embodiments, the laminate has an oxygen transmission rate (OTR) of no greater than about 0.5 g/m² per day, such as no greater than about 0.2 g/m² per day. In some preferred embodiments, the laminate has an oxygen transmission rate (OTR) of no greater than about 0.1 g/m² per day. In some preferred embodiments, the laminate composition has an oxygen transmission rate (OTR) of no greater than about 0.05 g/m² per day.

It has also been found that the laminate may provide high barrier properties, whilst also maintaining excellent mechanical properties, such as coefficient of friction, heat seal properties, bond strength, stiffness, and seal through contamination.

### Process

In one aspect there is provided a method of preparing a multi-layer film composition as described hereinabove, the method comprising:
(a) providing the first, second and third layers in separate containers;
(b) melting the polymers in the first, second and third layers in the separate containers;
(c) combining the first, second and third layers to form a multi-layer film composition.

The first, second and third layers may be provided as described hereinabove. The first layer comprises at least a cyclic olefin copolymer; the second layer comprises at least polyethylene; and the third layer comprises at least a polymer having a heat seal initiation temperature of no greater than about 170° C. The expression “providing the first, second and third layers in separate containers” may thus be interpreted to mean that the materials or polymer resins that make up each of the first, second and third layers are provided in a first, second and third container, respectively. For example, a first container is provided with at least a COC resin (i.e. the components of the first layer), a second container is provided with at least polyethylene optionally in combination with an anti-block additive (i.e. the components of the second layer), and a third container is provided with at least a polymer having a heat seal initiation temperature of no greater than about 170° C. optionally in combination with an additional polymer and/or an anti-block additive (i.e. the components of the third layer).

In some embodiments, the multi-layer film composition is a cast polyethylene film. In such embodiments, the apparatus used for the above process may be a casting line. In such embodiments, the three layers (each of which includes at least one polymer resin) may be provided in individual hoppers of a casting line, such as a co-extrusion casting line. The resins in the three layers may be melted evenly in their individual hoppers at an optimum temperature range in step (b). Subsequently, the three layers may be pushed by screws at a consistent temperature from the individual hoppers into an extrusion die, and the three layers thus combined. The three layers may thus be co-extruded into a cast polyethylene film.

The polymers in the first, second and third layers may be melted in step (b) above, preferably in individual hoppers on a casting line, at temperatures from at least about 200° C., and preferably at least about 230° C. The melting temperatures may be from about 200° ° C. to about 300° C. It may be preferred where the process is a carried out in a co-extrusion casting line that the melting temperatures are set in the range of from about 230° ° C. to about 245° C., as this temperature range may ensure a smooth run and may reduce instances of film breaking from the extrusion die. Where temperatures of less than 230° C. are used, the film may be susceptible to tears or holes forming along its length.

In embodiments where the process is carried out in a casting line, such as a co-extrusion casting line, the casting line speed may preferably be at least 80% of the machine capacity as this may improve material flow compatibility. Preferably, the casting line speed may be at least about 100 m/min.

In some embodiments, the multi-layer film composition is cured after step (c) of the above process. Therefore, in some embodiments, the process comprises (a) providing the first, second and third layers in separate containers;
(b) melting the polymers in the first, second and third layers in the separate containers;
(c) combining the first, second and third layers to form a multi-layer film composition; and
(d) curing the multi-layer film composition.

The multi-layer film composition may be cured for a period of at least about 2 days prior to subsequent handling or processing.

In some embodiments, the multi-layer film composition may subsequently be metallised. For example, where the film composition is a cast polyethylene film, the composition may be metallised to provide a metallised cast polyethylene film (MCPE). The metallising step may be carried out using a vacuum metallising machine that is known to a person skilled in the art. The metal used in this step (such as aluminium) may first be evaporated to a gas, and then the gaseous metal deposited onto the surface of the multi-layer film composition. The resulting metallised film composition may subsequently be cooled either actively or passively.

The following is a detailed description of one suitable method for preparing a metallised multi-layer film composition, preferably a metallised cast polyethylene film where the cast polyethylene film is prepared as described above. The air in a chamber in a vacuum metallising machine is first removed such that the resulting chamber is under vacuum. Aluminium wire in the chamber is then evaporated to a gas. A multi-layer film composition (preferably a cast polyethylene film) is introduced to the machine, and the gaseous aluminium deposited onto its surface. The metallised film produced is then cooled using a cooling roller, and the metallised film rewound onto a rewinder. The vacuum level in the chamber be from about 4×10⁻³ to about 4×10⁻⁴ mbar. The optical density settings may be from about 2.5 to about 2.8.

The optical density of the resulting metallised film may be from about 2.5 to about 2.8 using UV light, and the metal adhesion to the film may be at least about 500 g/inch.

The resulting metallised film composition may subsequently be cured for at least about 1 day prior to subsequent handling or processing.

As noted hereinabove, the multi-layer composition may further comprise an external printable layer, such as OPP or OPE. Where an external printable layer is included, such layer may be applied via a step of lamination. For example, a solvent-based laminator or a solvent-free laminator may be used here. The multi-layer film composition (preferably a CPE, and more preferably an MCPE) may be first coated with an adhesive and then laminated with OPP and/or OPE on a roller. The resulting film with OPP and/or OPE laminated thereon may be left to cure for a period of at least one day. The adhesive used in the lamination step may be a solvent-free or solvent-based polyurethane, polyether or acrylic based adhesive. The line-speed using in the lamination may be from about 150 to about 250 m/min.

Where a solvent-based laminator is used, the process may further include a step of drying after adding the adhesive and before lamination. The drying step may be carried out at a temperature of from about 70 to about 90° C. Zonal drying may be implemented with zone 1 using a temperature of from 70-80° C.; zone 2 from 80-90° C. and zone 3 from 80-90° C.

The tear strength of a metallised cast polyethylene film laminated with OPP and/or OPE in this manner may be no greater than about 2 N. The coefficient of friction between the first layer and the metal layer may be from about 0.1 to about 0.25, and the coefficient of friction between the metal layer and the external printable layer may be from about 0.2 to about 0.4.

### Process of Preparing Laminate

The laminate as described herein may be prepared using a process that is similar to that described hereinabove for the multi-layer film composition. Preferably, the first barrier layer comprising a metallised multi-layer film composition and the second barrier layer comprising metallised oriented polypropylene are provided in separate containers, and then combined. The step of combining the first and second barrier layers may be via extrusion as described hereinabove.

The external printable layer comprising a polymer selected from oriented polypropylene, oriented polyethylene and combinations thereof may then be applied as described above for the step of applying such an external printable layer to a multi-layer film composition.

### Use

The multi-layer film composition described herein may be suitable for use in preparing a packaging for a food or beverage product. The packaging may be suitable for use as a single serve packaging or a multi-serve packaging. In some embodiments, the packaging may be for use as a single serve packaging for coffee products (e.g. dried coffee granules, ground coffee beans, filter coffee granules, or the like). Such single serve packaging may be in the form of a sachet that is able to be manually torn by a user without additional equipment (e.g. scissors) being required).

The laminate described herein may also be suitable for use in preparing a packaging for a food or beverage product. The packaging may be suitable for use as a single serve packaging or a multi-serve packaging. In some embodiments, the packaging may be for use as a single serve packaging for coffee products (e.g. dried coffee granules, ground coffee beans, filter coffee granules, or the like). Such single serve packaging may be in the form of a sachet that is able to be manually torn by a user without additional equipment (e.g. scissors) being required).

As described herein, there is provided a use of a cyclic olefin copolymer in a multi-layer film composition comprising polyethylene for improving adhesion of the film composition to a metal layer. As noted hereinabove, it has been found that the inclusion of a COC in a layer between the polyethylene and the metal layer in a metallised film composition provides for improved adhesion and improved barrier properties as compared with metallised polyethylene films that do not contain a COC.

As described herein, there is also provided the use of a cyclic olefin copolymer for providing a metallised film composition having a water vapour transmission rate of no greater than 0.1 g/m² per day, the metallised film composition comprising the cyclic olefin copolymer.

Additionally, there is also provided the use of a cyclic olefin copolymer for providing a metallised film composition having an oxygen transmission rate of no greater than 0.1 g/m² per day, the metallised film composition comprising the cyclic olefin copolymer.

### EXAMPLES

### Example 1

Three metallised multi-layer film compositions were prepared: Samples 1-A, 1-B and 1-C. A comparative Sample 1-D was also prepared.

Samples 1-A to 1-D were prepared via a co-extrusion casting line. The COC and optionally LDPE in the first layer were provided in a first hopper; the LLDPE in the second layer was provided in a second hopper; and the POP and LDPE in the third layer were provided in a third hopper. For sample 1-D only the second and third hoppers were used. Each of the resins in the individual hoppers were then melted at a temperature of 230-245° C., and then pushed by screws into an extrusion die. The casting line speed was set at greater than 100 m/min, and the three layers co-extruded to form a cast polyethylene film. The film was subsequently metallised to provide an MCPE. The cast polyethylene film was introduced into a vacuum metallising machine, in which a first chamber is under vacuum (10-3 to 10-4 mbar). In this first chamber, aluminium wire was evaporated to a gas, which was then deposited onto the surface of the CPE. The film was cooled using a cooling roller. The optical density settings were 2.5 to 2.8. The MCPE film produced was then cured for 24 hours.

Each of these samples included oriented polypropylene (OPP) adhered to a metallised cast polyethylene film (MCPE). The thickness of the OPP layer was 30 μm, and the total thickness of the MCPE was 35 μm (i.e. the total thickness of the metal, first, second and third layers). Each of the MCPE films had the following structures:

Aluminium
First layer - ‘skin’ layer
Second layer - ‘core’ layer
Third layer - ‘sealant’ layer

Samples 1-A to 1-D had the following compositions in the MCPE, where the percentage by weight of each component is provided based on the total weight of the first, second and third layers. As noted above, each of these MCPE films was metallised using aluminium and adhered to an OPP layer such that the thickness of the OPP layer was 30 microns and the thickness of the MCPE film was 35 microns.

| | | | | |
|---|---|---|---|---|
| | | | | Sample 1-D |
| | Sample 1-A | Sample 1-B | Sample 1-C | (comparative) |
| | (% by weight | (% by weight | (% by weight | (% by weight of |
| | of layers (i), | of layers (i), | of layers (i), | layers (i), (ii) |
| Component | (ii) and (iii)) | (ii) and (iii)) | (ii) and (iii)) | and (iii)) |

First layer

| | | | | |
|---|---|---|---|---|
| COC | 4.8% (60% by | 8% (100% by | 5.7% (100% by | — |
| | weight of | weight of | weight of | |
| | first layer) | first layer) | first layer) | |
| LDPE | 3.2% (40% by | — | — | — |
| | weight of | | | |
| | first layer) | | | |

Second layer

| | | | | |
|---|---|---|---|---|
| LLDPE | 66.3% | 66.3% | 68.6% | 75% |
| Slip additive | 0.7% | 0.7% | 0.7% | — |

Third layer

| | | | | |
|---|---|---|---|---|
| Polyolefin plastomer | 18.75% (75% by | 18.75% (75% by | 18.75% (75% by | 18.75% (75% by |
| | weight of | weight of | weight of | weight of |
| | third layer) | third layer) | third layer) | third layer) |
| LLDPE | 5.75% (23% by | 5.75% (23% by | — | — |
| | weight of | weight of | | |
| | third layer) | third layer) | | |
| LDPE | — | — | 6.875% (27.5% | 6.875% (27.5% by |
| | | | by weight of | weight of |
| | | | third layer) | third layer) |
| Anti-block Additive | 0.5% (2% by | 0.5% (2% by | 0.625% (2.5% by | 0.625% (2.5% by |
| | weight of | weight of | weight of | weight of |
| | third layer) | third layer) | third layer) | third layer) |

The following properties of each of these samples were measured, and the results are shown in the Table below:

| | | | | Sample 1-D |
|---|---|---|---|---|
| Component | Sample 1-A | Sample 1-B | Sample 1-C | (comparative) |
| WVTR | 0.4 g/m² | <0.1 g/m² | <0.1 g/m² | >2 g/m² |
| (ASTM F1249, | per day | per day | per day | per day |
| 37.8° C., 90% RH) | | | | |
| Tearing Strength | ≤2N | ≤2N | ≤2N | >4N |
| Bond Strength (ASTM | ≥2N/15 mm | ≥2N/15 mm | ≥2N/15 mm | ≥2N/15 mm |
| F904) | | | | |
| Seal Strength | ≥10N/15 mm | ≥10N/15 mm | ≥10N/15 mm | ≥10N/15 mm |

The barrier properties of the samples including COC in a first layer were found to be significantly improved compared to a sample not including COC. The tearing strength was also found to be lower for samples according to the present invention, which resulted in the user being able to more easily manually tear the composition in a straight line.

### Example 2

Sample 2-1: This cast metallised polymer film having the components shown in the table below was prepared according to the method in Example 1.

Comparative Samples 2-2, 2-3 and 2-4 are films available on the market. Sample 2-3 may be, for example, PT Indopoly's SMMU MOPP18 or Jindal MM483 MOPP16. Sample 2-4 may be, for example, Amcor MCPP25-40u or Daibochi MCPP25-40u.

| | | | Comparative | |
|---|---|---|---|---|
| | | Comparative | Sample 2-3 | Comparative |
| | Sample 2-1 | Sample 2-2 | Metallized | Sample 2-4 |
| | High Barrier | Oriented | Oriented | Metallized |
| | Metallized | Metallized | Polypro- | Cast |
| Sample | Polyethylene | Polyethylene | pylene | Polypropylene |
| Material | Metal layer - | Metal layer - | Metal layer - | Metal layer - |
| layers | Aluminium | Aluminium | Aluminium | Aluminium |
| | COC | LLDPE | EVOH | Terpolymer PP |
| | LLDPE | LLDPE | Tie | Copolymer PP |
| | Low Seal PE - | Low Seal PE - | Copolymer | Terpolymer PP |
| | polyolefin | polyolefin | PP | |
| | plastomer + | plastomer + | | |
| | LDPE | LDPE | | |
| | | | Terpolymer | |
| | | | PP | |

Each of the samples were analysed for physical and chemical properties. The results are shown in the Table below:

| | | | Comparative | | Comparative | | | |
|---|---|---|---|---|---|---|---|---|
| | Sample 2-1 | | Sample 2-2 | | Sample 2-3 | | Comparative | |
| | High Barrier | | Oriented | | Metallized | | Sample 2-4 | |
| | Metallized | | Metallized | | Oriented | | Metallized Cast | |
| | Polyethylene | | Polyethylene | | Polypropylene | | Polypropylene | |
| WVTR | ≤0.1 | g/m² · d | ≤0.1 | g/m² · d | ≤0.1 | g/m² · d | ≤0.1 | g/m² · d |
| ASTM F1249 | | | | | | | | |
| OTR | ≤0.1-3 | cc/m² · d | >8 | cc/m² · d | ≤0.1 | cc/m² · d | ≤10 | cc/m² · d |
| ASTM F1927 | | | | | | | | |

| | | | | | | | |
|---|---|---|---|---|---|---|---|
| Heat seal | 90-150° | C. | >127° | C. | Not Heat Sealable | 110-150° | C. |
| temperature | | | | | | | |

| | | | | |
|---|---|---|---|---|
| Heat seal | 10N-40N/ | 8N/15 mm | Either not sealable | 10N-30N/15 mm |
| strength | 15 mm | (Depends on | or <3N/ | (Depends on |
| | (Depends on | Thickness) | 15 mm | Thickness) |
| | Thickness) | | | |
| Tearing | <2N | >4N | <2N | >5N |
| strength | (Low | (Medium Tear | (Low | (Medium Tear |
| | Resistance) | Resistance) | Resistance) | Resistance) |
| Coefficient of | 0.10-0.25 | 0.4-0.6 | 0.2-0.4 | 0.4-0.6 |
| friction | (High Slip) | (Low Slip) | (Medium Slip) | (Low Slip) |
| (between film | | | | |
| and metal) | | | | |

The present disclosure also relates to embodiments disclosed in the following numbered paragraphs:
1. A multi-layer film composition comprising:
(i) a first layer comprising a cyclic olefin copolymer;
(ii) a second layer comprising polyethylene; and
(iii) a third layer comprising a polymer having a heat seal initiation temperature of no greater than about 150° ° C.;
wherein the second layer is positioned between the first and third layers.
2. A multi-layer film composition comprising:
(i) a first layer comprising a cyclic olefin copolymer;
(ii) a second layer comprising polyethylene; and
(iii) a third layer comprising a polymer having a heat seal initiation temperature of no greater than about 150° C.;
wherein the second layer is positioned between the first and third layers, and
wherein the multi-layer film composition has a water vapour transmission rate of no greater than about 0.5 g/m² per day.
3. The multi-layer film composition according to paragraph 1 or 2, wherein the first layer is present in an amount of from about 5% to about 15% based on the total combined weight of layers (i), (ii) and (iii).
4. The multi-layer film composition according to any one of the preceding paragraphs, wherein the cyclic olefin copolymer in the first layer has a glass transition temperature of from about 50° ° C. to about 100° C.
5. The multi-layer film composition according to any one of the preceding paragraphs, wherein the first layer comprises a cyclic olefin copolymer in an amount of about 100% based on the total weight of the first layer.
6. The multi-layer film composition according to any one of the preceding paragraphs, wherein the second layer is present in an amount of from about 65% to about 75% based on the total combined weight of layers (i), (ii) and (iii).
7. The multi-layer film composition according to any one of the preceding paragraphs, wherein the second layer comprises a polyethylene polymer selected from the group consisting of linear low-density polyethylene, low density polyethylene, medium density polyethylene, and combinations thereof.
8. The multi-layer film composition according to any one of the preceding paragraphs, wherein the second layer comprises polyethylene having a melt flow index of from about 1.5 g/10 min to about 2.5 g/10 min as measured at 190° C./2.16 kg.
9. The multi-layer film composition according to any one of the preceding paragraphs, wherein the third layer is present in an amount of from about 20% to about 30% based on the total combined weight of layers (i), (ii) and (iii).
10. The multi-layer film composition according to any one of the preceding paragraphs, wherein the third layer comprises a polyolefin plastomer, optionally in combination with a low-density polyethylene.
11. The multi-layer film composition according to any one of the preceding paragraphs, wherein the third layer comprises a polyolefin plastomer having a heat seal initiation temperature of from about 80° C. to about 100° C.
12. The multi-layer film composition according to any one of the preceding paragraphs, wherein the third layer comprises (a) a polyolefin plastomer in an amount of from about 70% to 80% by weight of the third layer, and (b) low-density polyethylene in an amount of from about 20% to about 30% by weight of the third layer.
13. The multi-layer film composition according to any one of the preceding paragraphs, wherein the first layer has a first surface and a second surface, wherein the second surface is in contact with the second layer, and wherein the first surface is not in contact with the second layer.
14. The multi-layer film composition according to paragraph 13 further comprising a metal layer in contact with the first surface of the first layer.
15. The multi-layer film composition according to paragraph 14, wherein the metal layer comprises or consists of aluminium.
16. The multi-layer film composition according to paragraph 14 or 15, wherein the film composition has an oxygen transmission rate of no greater than about 0.1 g/m² per day; and/or a coefficient of friction between the first layer and the metal layer of from about 0.2 to about 0.3.
17. The multi-layer film composition according to paragraph 1, having a water vapour transmission rate of no greater than about 0.1 g/m² per day.
18. The multi-layer film composition according to any one of the preceding paragraphs further comprising an external printable layer, wherein the external printable layer comprises a polymer selected from oriented polypropylene, oriented polyethylene and combinations thereof.
19. A method of preparing a multi-layer film composition according to any one of the preceding paragraphs, the method comprising:
   (a) providing the first, second and third layers in separate containers;
   (b) melting the polymers in the first, second and third layers in the separate containers; and
   (c) combining the first, second and third layers to form a multi-layer film composition.
20. A laminate comprising:
   (a) a first barrier layer comprising a metallised multi-layer film composition according to any one of paragraphs 14 to 16;
   (b) a second barrier layer comprising metallised oriented polypropylene; and
   (c) an external printable layer comprising a polymer selected from oriented polypropylene, oriented polyethylene and combinations thereof.
21. The laminate according to paragraph 20, further comprising an intermediate layer between the external printable layer and the second barrier layer, the intermediate layer comprising polyethylene.
22. The laminate according to paragraph 20 or 21, wherein the total thickness of the laminate is from about 50 μm to about 200 μm.
23. The laminate according to any one of paragraphs 20 to 22,
wherein the thickness of the first barrier layer is from about 20 μm to about 80 μm and/or
wherein the thickness of the second barrier layer is from about 5 μm to about 20 μm.
24. Use of a cyclic olefin copolymer in a multi-layer film composition comprising polyethylene for improving adhesion of the film composition to a metal layer.
25. Use of a cyclic olefin copolymer for providing a metallised film composition having a water vapour transmission rate of no greater than 0.1 g/m² per day, the metallised film composition comprising the cyclic olefin copolymer.

Various modifications and variations of the present invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry, biology or related fields are intended to be within the scope of the following claims.

1. A multi-layer film composition comprising:
(i) a first layer comprising a cyclic olefin copolymer;
(ii) a second layer comprising polyethylene;
(iii) a third layer comprising a polymer having a heat seal initiation temperature of no greater than about 170° C.; and
the second layer is positioned between the first and third layers.

2. A multi-layer film composition comprising:
(i) a first layer comprising a cyclic olefin copolymer;
(ii) a second layer comprising polyethylene;
(iii) a third layer comprising a polymer having a heat seal initiation temperature of no greater than about 170° C.;
the second layer is positioned between the first and third layers, and
the multi-layer film composition has a water vapour transmission rate of no greater than about 0.5 g/m² per day.

3. The multi-layer film composition according to claim 1, wherein:
the first layer is present in an amount of from about 5% to about 15% based on the total combined weight of layers (i), (ii) and (iii);
the second layer is present in an amount of from about 65% to about 75% based on the total combined weight of layers (i), (ii) and (iii); and
the third layer is present in an amount of from about 20% to about 30% based on the total combined weight of layers (i), (ii) and (iii).

4. The multi-layer film composition according to claim 1, wherein the cyclic olefin copolymer in the first layer has a glass transition temperature of from about 50° ° C. to about 100° C.

5. The multi-layer film composition according to claim 1, wherein the cyclic olefin copolymer is a copolymer of norbornene and ethylene.

6. The multi-layer film composition according to claim 1, wherein the second layer comprises a polyethylene polymer selected from the group consisting of linear low-density polyethylene, low density polyethylene, medium density polyethylene, and combinations thereof.

7. The multi-layer film composition according to claim 1, wherein the third layer comprises a polyolefin plastomer.

8. The multi-layer film composition according to claim 1, wherein the third layer comprises a polyolefin plastomer having a heat seal initiation temperature of from about 80° C. to about 110° C.

9. The multi-layer film composition according to claim 1,
wherein the first layer has a first surface and a second surface,
the second surface is in contact with the second layer,
wherein the first surface is not in contact with the second layer, and
the multi-layer film composition further comprises a metal layer in contact with the first surface of the first layer.

10. The multi-layer film composition according to claim 9, wherein the film composition has a water vapour transmission rate of no greater than about 0.1 g/m² per day;
an oxygen transmission rate of no greater than about 0.1 g/m² per day; and
a coefficient of friction between the first layer and the metal layer of from about 0.2 to about 0.3.

11. The multi-layer film composition according to claim 1 further comprising an external printable layer, wherein the external printable layer comprises a polymer selected from the group consisting of oriented polypropylene, oriented polyethylene and combinations thereof.

12. (canceled)

13. A laminate comprising:
(a) a first barrier layer comprising a metallised multi-layer film composition comprising:
(i) a first layer comprising a cyclic olefin copolymer:
(ii) a second layer comprising polyethylene;
(iii) a third layer comprising a polymer having a heat seal initiation temperature of no greater than about 170° C.; and
the second layer is positioned between the first and third layers;
(b) a second barrier layer comprising metallised oriented polypropylene; and
(c) an external printable layer comprising a polymer selected from oriented polypropylene, oriented polyethylene and combinations thereof.

14-15. (canceled)
